(19) United States
(12) Patent Application Publication
(10) Pub. No.: US 2025/0315698 A1
(43) Pub. Date: Oct. 9, 2025

(54) Trouble Document Processing Device and Trouble Document Processing Method

(71) Applicant: Hitachi, Ltd., Tokyo (JP)

(72) Inventors: Tatsuya BABA, Tokyo (JP); Shuichi NISHINO, Tokyo (JP); Kenichi SHIMBO, Tokyo (JP); Tadanobu TOBA, Tokyo (JP)

(21) Appl. No.: 19/071,902

(22) Filed: Mar. 6, 2025

(30) Foreign Application Priority Data
Apr. 9, 2024 (JP) 2024-062436

(51) Int. Cl. G06N 5/04; G06F 40/295

(52) U.S. Cl. CPC G06N 5/04; G06F 40/295

(57) ABSTRACT

To create a trouble knowledge database which can be used for trouble cause diagnosis by extracting trouble information by a uniform expression from a trouble report sentence including fluctuations in expression.

A trouble document processing device includes a trouble knowledge database storing information regarding a trouble, a hardware knowledge database storing a name of a part in a product, its synonym, and design information, an input/output unit inputting and outputting information, and a processor unit performing a predetermined computing process. The processor unit performs a named entity extracting process of extracting a term related to a component of a target product and a trouble of the component from a trouble report sentence, a relationship extracting process of extracting a relationship between named entities from the trouble report sentence, a named entity and relationship integrating process of generating first graph data from a result of the named entity extracting process and a result of the relationship extracting process, a data matching process of generating second graph data obtained by collating a named entity in the first graph data with the hardware knowledge database and correcting a synonymous element, a graph integrating process of generating third graph data by connecting the second graph data and the named entity in the trouble knowledge database, and a trouble knowledge database updating process of collating the third graph data and the trouble knowledge database and updating the trouble knowledge database.

### CLAIM OF PRIORITY

The present application claims priority from Japanese Patent application serial no. 2024-062436, filed on Apr. 9, 2024, the content of which is hereby incorporated by reference into this application.

### BACKGROUND OF THE INVENTION

The present invention relates to a trouble document processing device and a trouble document processing method for extracting a cause of a trouble of a product from a trouble report in which the trouble is written and creating a trouble knowledge database.

In many cases, when a trouble occurs in industrial products, products/devices for the public, and the like, a report regarding the trouble (trouble report) is made by a maintenance personnel or the like who handled the trouble, and further investigation or the like for the place and the root cause of the trouble is performed on the basis of the trouble report. In the report from the maintenance personnel, various information regarding the situation during operation of the product/device and the cause of the trouble is written. By utilizing the information for trouble handling and next-generation designing, the reliability of the product can be further improved. It is also expected to increase the efficiency and the level of feedback and maintenance to the next-generation designing by extracting information of a component related to the status of a product which occurred during operation from a report of a maintenance personnel and systemizing the information.

On the other hand, it is difficult to process trouble reports by using a stereotypical rule base or word dictionary since expressions (fluctuations in descriptions, differences in languages, and the degree of the details) vary among maintenance personnels. To solve the problem, attention is being paid to a language processing model capable of solving various tasks by changing an input directive such as LLM (Large Language Models) as a kind of generative AI. The LLM has high processing performance for variations in expression by learning in large-scale data and plural tasks, and utilization to information extraction in which ambiguity in description is solved from a trouble report of an industrial product is being promoted.

Conventionally, as an invention of solving ambiguity by performing data matching on information extracted from a maintenance document to create knowledge of failures, there is one described in Japanese Unexamined Patent Application Publication No. 2023-32128. As an invention of integrating information extracted from a plurality of information sources and information on a database, performing machine learning on the basis of the integrated information, and obtaining an inference result, there is one described in Japanese Unexamined Patent Application Publication No. 2019-79216 (Japanese Patent No. 7021499).

### SUMMARY OF THE INVENTION

In Japanese Unexamined Patent Application Publication No. 2023-32128, data matching process is executed based on the co-occurrence relation of a combination between a failure expression and a procedure expression. However, in extraction of a complicated trouble occurrence mechanism having a larger number of components, the number of combinations becomes enormous. Further, as described above, there is a case where sentence expressions for the same incident vary in trouble report sentences among report writers. Consequently, a desired result may not be obtained depending on a target product.

In Japanese Unexamined Patent Application Publication No. 2019-79216 (Japanese Patent No. 7021499), a process of integrating information from a plurality of information sources directly with information on a database is executed. To integrate information obtained from trouble reports, there is a case where a problem of fluctuations in description for the same incident has to be solved.

It is consequently considered to construct knowledge by extracting information from trouble reports by using a language processing model learned from a massive amount of data. However, the language processing model does not always learn knowledge regarding parts names and phenomena of industrial products, and there is the possibility that the precision of a response regarding a trouble of an industrial product is low.

The present invention is made in consideration of the above-described points, and an object of the invention is to create a trouble knowledge database which can be used for a trouble cause diagnosis by extracting trouble information by a uniform expression from trouble report sentences including fluctuations in expression.

To solve the above-described problems, the present invention provides a trouble document processing device of extracting a cause of a trouble from a trouble report describing a trouble of a product and creating a trouble knowledge database, having: a trouble knowledge database storing information regarding a trouble; a hardware knowledge database storing a name of a part in a product, a synonym of the name, and design information; an input/output unit inputting and outputting information; and a processor unit performing a predetermined computing process. The processor unit performs: a named entity extracting process of extracting a term related to a component in a target product and its trouble from a trouble report sentence based on the trouble report; a relationship extracting process of extracting a relationship between named entities from the trouble report sentence; a named entity and relationship integrating process of generating first graph data from a result of the named entity extracting process and a result of the relationship extracting process; a data matching process of obtaining second graph data derived by collating a named entity in the first graph data with the hardware knowledge database and correcting a synonymous element; a graph integrating process of generating third graph data by connecting the second graph data and the named entity in the trouble knowledge database; and a trouble knowledge database updating process of collating the third graph data and the trouble knowledge database and updating the trouble knowledge database.

A trouble knowledge database is updated by information extracted from a trouble report without recognizing the same incident as a different incident. Objects, configurations, and effects other than the above will be apparent from the description of the embodiments in the following invention.

### BRIEF DESCRIPTION OF THE DRAWINGS

FIG. 1A is a configuration diagram of a trouble document processing device in a present embodiment.

FIG. 1B illustrates an example of a trouble knowledge database (DB) in the present embodiment.

FIG. 1C illustrates an example of a hardware (HW) knowledge DB in the present embodiment.

FIG. 1D illustrates an example of the HW knowledge DB in the present embodiment.

FIG. 2 is a diagram for explaining the flow of document process in the present embodiment.

FIG. 3 is a flowchart of the document process in the present embodiment. FIG. 4A illustrates an example of a trouble report in the present embodiment.

FIG. 4B illustrates an example of a trouble report sentence in the present embodiment.

FIG. 4C illustrates an example of a named entity extraction sentence in the present embodiment.

FIG. 4D illustrates an example of a named entity list in the present embodiment.

FIG. 4E illustrates an example of a relationship extraction sentence in the present embodiment.

FIG. 4F illustrates an example of a relationship list in the present embodiment.

FIG. 4G illustrates an example of graph data in the present embodiment.

FIG. 4H illustrates an example of a data matching process sentence in the present embodiment.

FIG. 4I illustrates an example of table data in the present embodiment.

FIG. 4J illustrates an example of corrected graph data in the present embodiment.

FIG. 4K illustrates an example of partial graph data in the embodiment.

FIG. 4L illustrates an example of integrated graph data in the present embodiment.

FIG. 4M illustrates an example of an updated trouble knowledge DB in the embodiment.

FIG. 5 is a diagram for explaining the flow of another example of a document process in the present embodiment.

FIG. 6A illustrates an example of a relationship list in the present embodiment.

FIG. 6B illustrates an example of partial graph data in the present embodiment.

FIG. 6C illustrates an example of an HW knowledge DB in the present embodiment.

FIG. 6D illustrates an example in which an explanation sentence is added to a trouble report sentence in the present embodiment.

FIG. 6E illustrates an example of dictionary data in the present embodiment.

FIG. 6F illustrates an example of partial graph data in the present embodiment.

FIG. 7 illustrates another example of the flowchart of the document process in the present embodiment.

FIG. 8 illustrates an example of a correction process sentence in the present embodiment.

### DETAILED DESCRIPTION

Hereinafter, embodiments of the present invention will be described with reference to the drawings. The embodiments are examples for describing the present invention. To clarify the description, omission and simplification are properly made. The present invention can be implemented by other various modes. Unless otherwise limited, each of components may be singular or plural.

The position, size, shape, range, and the like of each of components illustrated in the drawings may not express the actual position, size, shape, range, and the like to facilitate understanding of the invention. Consequently, the present invention is not always limited to the positions, the sizes, the shapes, the ranges, and the like disclosed in the drawings.

Various information will be described using expressions such as “table” and “list” as an example but may be expressed by other data structures. For example, the various information such as “XX table” and “XX list” may be expressed as “XX information”. At the time of explaining identification information, expressions such as “identification information”, “identifier”, “name”, “ID”, and “number” are used, and those expressions can be replaced with one another.

In the case where there are a plurality of components having the same or similar function, description may be given by adding different suffixes to the same reference numeral. In the case where the plurality of components do not have to be distinguished, description may be given without using the suffixes.

For the convenience of description, there is the case of describing the same component by designating different reference numerals in different drawings.

In the embodiment, there is the case of explaining a process which is performed by executing a program. In this case, a computer performs a process determined by a program by executing the program by a processor (for example, a CPU or GPU) while using a storage resource (for example, a memory), an interface device (for example, a communication port), and the like. Consequently, the processor may be set as the main body of the process performed by executing the program. Similarly, the main body of the process performed by executing the program may be a controller, a device, a system, a computer, or a node having the processor. A computing unit is sufficient as the main body of the process performed by executing the program, which may include a dedicated circuit performing a specific process. The dedicated circuit is, for example, an FPGA (Field Programmable Gate Array), an ASIC (Application Specific Integrated Circuit), a CPLD (Complex Programmable Logic Device), or the like.

A program may be installed from a program source to a computer. A program source may be, for example, a storage medium which can be read by a program distribution server or a computer. In the case where a program source is read by a program distribution server, the program distribution server may include a processor and a storage resource storing a program to be distributed, and the processor of the program distribution server may distribute the program to be distributed to another computer. In the embodiment, two or more programs may be realized as one program, and one program may be realized as two or more programs.

### First Embodiment

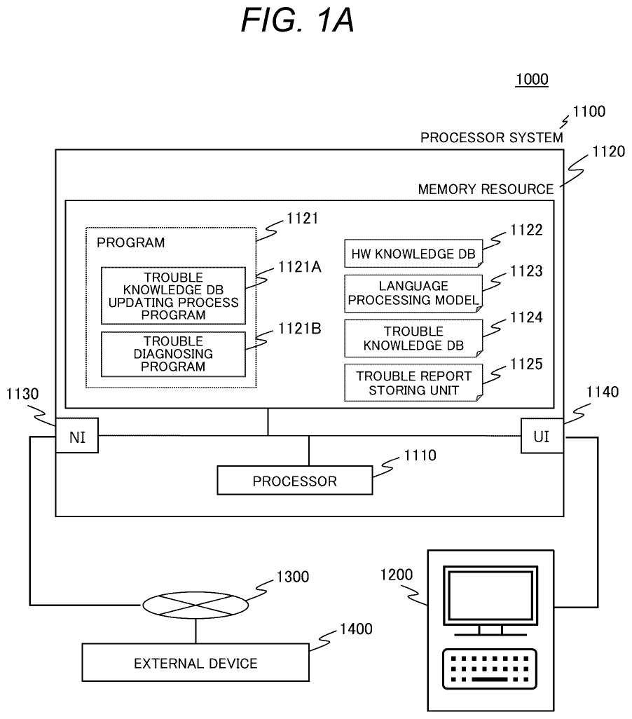

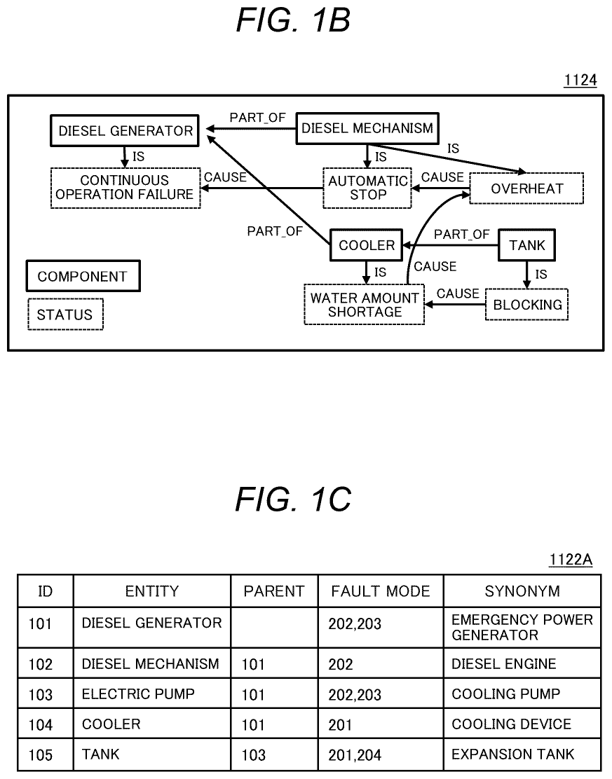

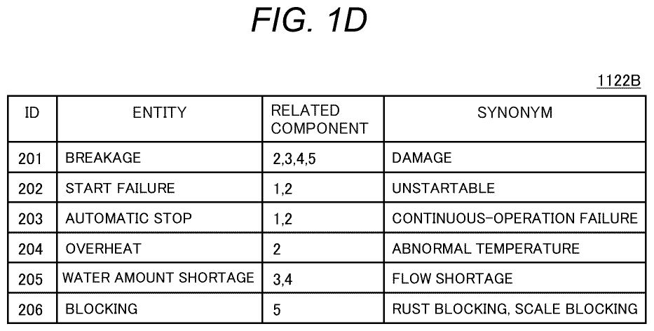

FIG. 1A is a configuration diagram of a trouble document processing device 1000 in a present embodiment. The trouble document processing device 1000 has a processor system 1100 realized by a personal computer, a general-purpose computer, or the like and an input/output device 1200 realized by a display device, a keyboard, and the like. A trouble document processing system is configured by including, as necessary, an external device 1400 connected via a network 1300.

The processor system 1100 has a processor unit 1110 executing computing process, a memory resource unit 1120 in which a program and data used for the computing process are stored, a network interface unit (NI) 1130 as an interface to an external network and the like, and a user interface unit (UI) 1140 as an interface to a display device, a keyboard, and the like used by the user (operator) of the device.

The memory resource unit 1120 has: a program unit 1121 in which programs (a trouble knowledge database (DB) updating process program 1121A and a trouble diagnosis process program 1121B) performing various processes which will be described later are stored; a hardware (HW) knowledge database (DB) 1122 in which a component of a system as a target of trouble diagnosis, the name of the trouble, and synonym expressions are collected; a language processing model 1123; a trouble knowledge DB 1124 in which information of a target product, a place (component) related to a trouble in a device, a phenomenon (status), and like is set as nodes and the relationships of the nodes are stored; and a trouble report storing unit 1125 storing the content of a trouble report. The processor unit 1110 performs a predetermined process by using the program unit 1121, the HW knowledge DB 1122, the language processing model 1123, the trouble knowledge DB 1124, the trouble report storing unit 1125, and the like.

As illustrated in FIG. 1B, the trouble knowledge DB 1124 stores, as nodes, the information such as places/components and phenomena (statuses) related to troubles in products and devices as targets and the relationships among them, and is a knowledge graph in which inclusive relations of the trouble places and their units are hierarchically expressed and a phenomenon (failure or status which can become the cause) which may occur in each of the parts is expressed as the reason or result of a phenomenon which may occur in another place. In the embodiment and, similarly, in other DBs and examples described hereinafter, a diesel generator is assumed as a target device.

In a knowledge graph in the present embodiment, an arrow expressing the occurrence place of a phenomenon by using the starting end as an occurrence place and using the termination end as a phenomenon will be called an “is edge”. As for a phenomenon, an arrow expressing a causal relation, using the starting end as the cause and using the termination end as a result will be called a “cause edge”. An arrow expressing an inclusion relation related to a trouble place, using the starting end as the component will be called a “part of edge”.

Coefficient information may be retained with respect to the causal relation expressed by the cause edge, and the coefficient information may be stored, for example, in a Bayesian network format provided with probability information such as conditional probability.

The HW knowledge DB 1122 is a database in which design information such as components of a system as a target of trouble diagnosis, a trouble name, and synonym expressions are collected, and is created by knowledge of system design books and specialists, and the synonym expressions are updated by update results of the trouble knowledge DB 1124.

The HW knowledge DB 1122 has a DB unit 1122A related to information of parts and configurations of hardware as illustrated in FIG. 1C and a DB unit 1122B related to hardware trouble terms as illustrated in FIG. 1D, each of which illustrates a part of the entire HW knowledge DB 1122.

In FIG. 1C, elements are “ID” storing a unique identification number, “Entity” storing a representative name of an HW component, “Parent” storing the ID of an upper component as an inclusive relation, “Fault Mode” storing the ID of an element which may occur in the HW knowledge DB 1122 related to trouble terms to be described later, and “Synonym” storing a list of synonyms referring to the name of the component.

In FIG. 1D, elements are “ID” storing a unique identification number, “Entity” storing the name of a trouble or a state, “Related Component” storing the ID of a component in which the trouble or the state may occur, and “Synonym” storing a list of synonyms of the names of troubles.

Another configuration may be employed in which the function of the HW knowledge DB 1122 is replaced by the trouble knowledge DB 1124 by storing the components of the HW knowledge DB 1122 in the trouble knowledge DB 1124. Specifically, it can be realized by making the element in the “Entity” table correspond to the name of the node in the trouble knowledge DB, making the element in the “Parent” table correspond to the “part of edge”, making the element in the “Fault Mode” table and the “Related Component” correspond to the “is edge”, and providing the element in the “Synonym” table as additional information of each node.

The language processing model 1123 is a language processing model which can solve various tasks by changing an input directive such as LLM (Large Language Models) as a kind of the generative AI. In the present embodiment, a prompt generated by a named entity extracting process, a relationship extracting process, a data matching process, and a graph integrating process is read, and each of the natural language processing tasks is executed.

As representative models, ChatGPT (Chat Generative Pre-Trained Transformer), FLAN (Fine-tuned Language Net), and the like are known. The model, however, is not limited to them and a specified language processing model. Any language processing model of generating a text in response to a directive may be employed. Although such language processing models may be generally described as “LLM” in the embodiments and the drawings, the invention is not limited to a specific language processing model.

The HW knowledge DB 1122, the language processing model 1123, the trouble knowledge DB 1124, and the trouble report storing unit 1125 may be provided in the external device 1400 or the like. In this case, the processor unit 1110 accesses the external device via the NI (1130), the network 1300, the API or the like and can obtain a process result which is necessary.

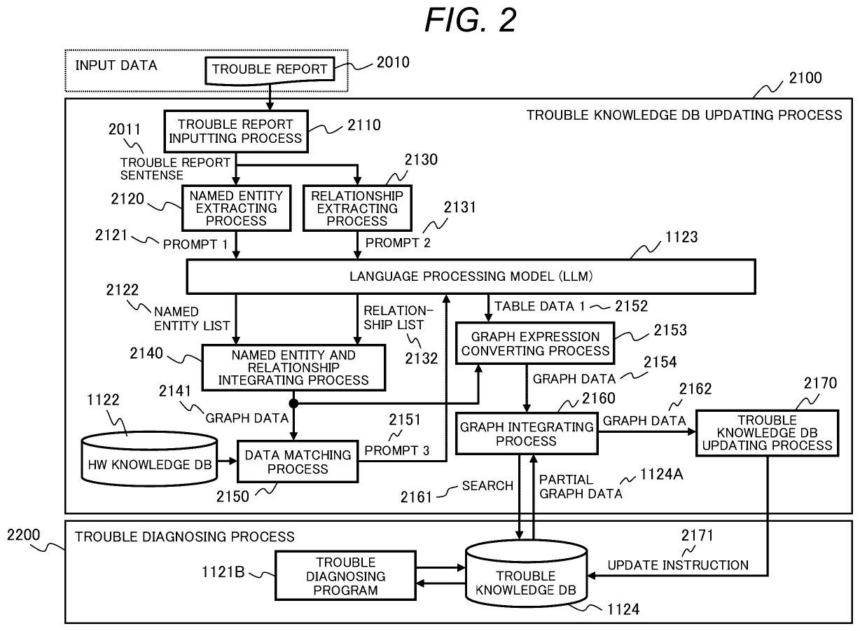

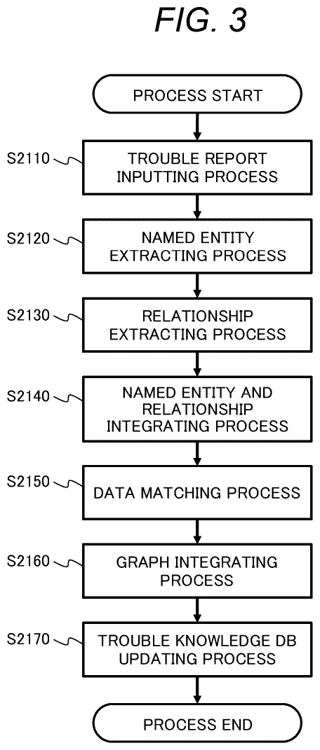

A trouble document process in the present embodiment will now be described. FIG. 2 is a diagram for explaining the flow of the trouble document process. FIG. 3 is a flowchart of the process. Hereinafter, description will be given in order of steps in the flowchart of FIG. 3 with reference to FIG. 2. Each of the steps in the flowchart is executed by the processor unit 1110 in FIG. 1.

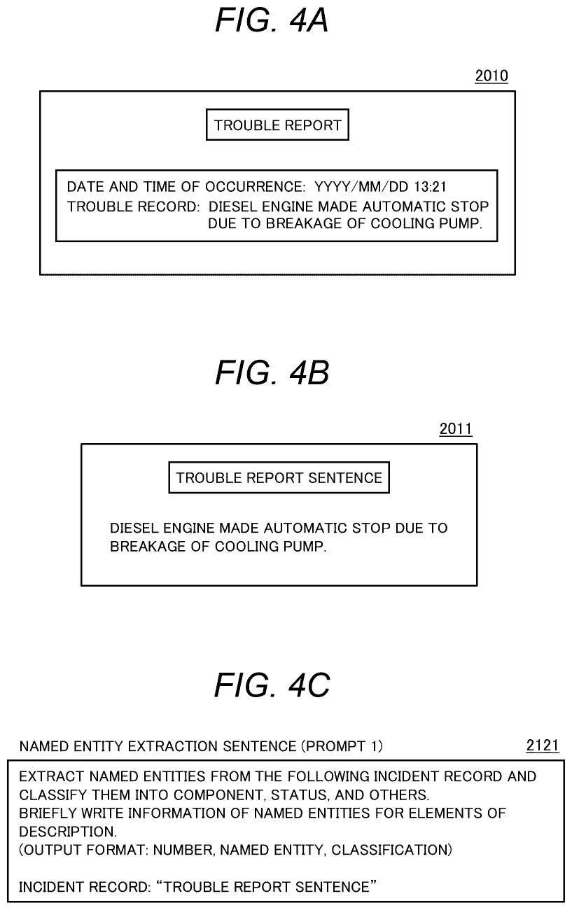

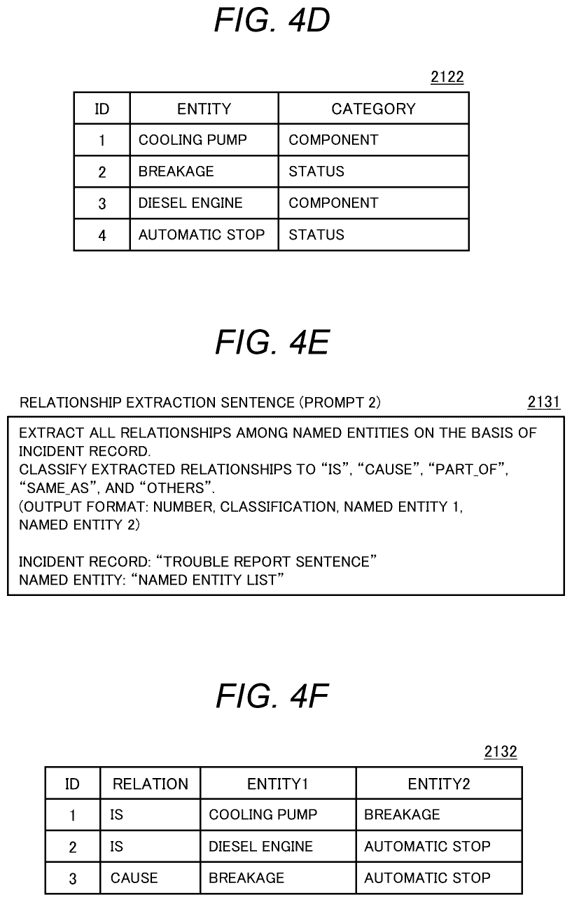

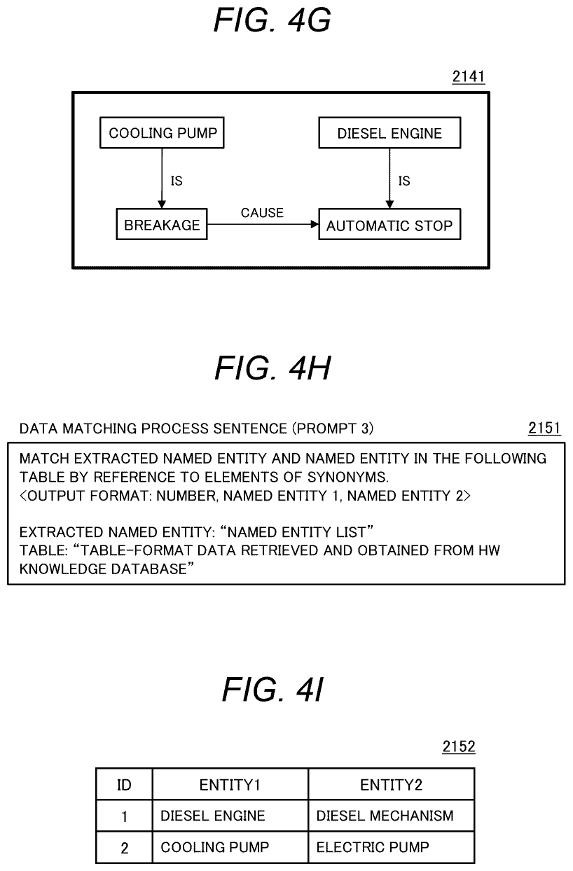

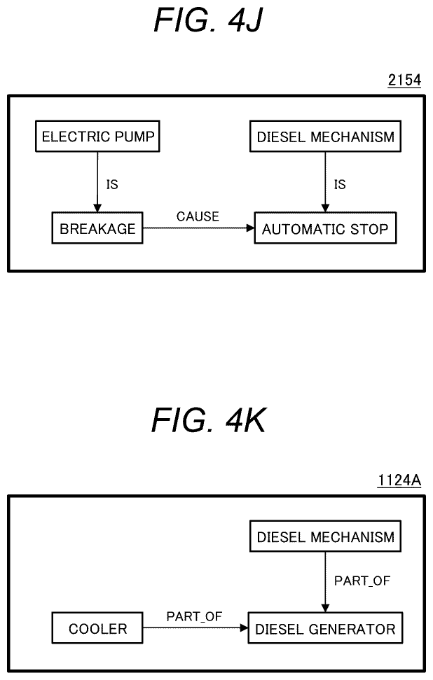

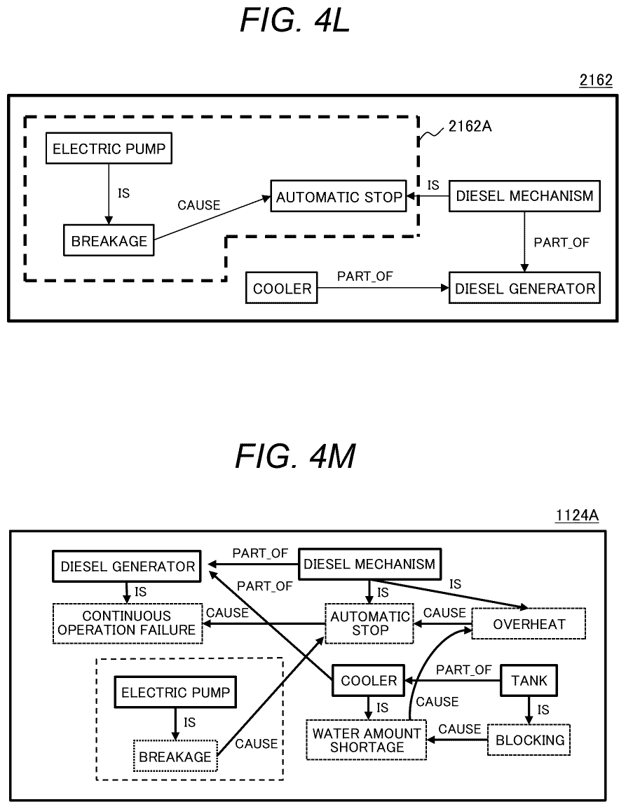

(Step S2110): In a trouble report inputting process 2110, a trouble report sentence 2011 obtained by extracting a part including description related to a trouble from a trouble report 2010 as input data is generated. FIGS. 4A and 4B illustrate an example of the trouble report 2010 and the trouble report sentence 2011.

(Step S2120): In a named entity extracting process 2120, a prompt 1 (2121) is generated which instructs the LLM 1123 to perform a process of extracting named entities such as a component of a product or system as a target and an expression related to a trouble of the product or system from the trouble report sentence, and outputting as a named entity list 2122 as a list form whose items are “entity” and “category”. FIG. 4C illustrates an example of the prompt 1 (2121). FIG. 4D illustrates an example of the named entity list 2122 which is output from the LLM 1123 on the basis of the prompt 1 (2121).

(Step S2130): In a relationship extracting process 2130, a prompt 2 (2131) is generated which instructs the LLM 1123 to perform a process of extracting relationships such as an inclusion relation and a causal relation in the named entity list (2122) obtained by the named entity extracting process and outputting a relationship list 2132 of a list form whose items are named entities having a relationship and a classification. FIG. 4E illustrates the prompt 2 (2131). FIG. 4F illustrates an example of the relationship list 2132 which is output from the LLM 1123 on the basis of the prompt 2 (2131).

(Step S2140): In a named entity/relationship integrating process 2140, from the named entity list 2122 and the relationship list 2132 output from the LLM 1123, data in a graphic form (graph data 2141) using an element on the named entity list 2122 as a node and an element on the relationship list 2132 as an edge is generated. FIG. 4G illustrates an example of the graph data 2141 in the present embodiment.

(Step S2150): In a data matching process 2150, to obtain graph data 2154 derived by correcting a synonymous element in the graph data 2141 created by the named entity and relationship integrating process, a prompt 3 (2151) instructing the LLM 1123 to perform a process of obtaining table data 1 (2152) in which a synonymous element is associated by collating with the HW knowledge DB 1122 is generated. In a graph expression converting process (2153), the graph data (2154) corrected on the basis of the table data 1 (2152) output from the LLM 1123 and the graph data 2141 is output.

FIG. 4H illustrates an example of the prompt 2151, and FIG. 4I illustrates an example of the table data 2152. FIG. 4J illustrates an example of the corrected graph data 2154. It is understood that the element in “diesel engine” in the graph data 2141 before correction is replaced by “diesel mechanism” in the graph data (2154) after correction (after data matching).

(Step S2160): In a graph integrating process 2160, the graph data (2154) obtained by the data matching process (S2150) and the named entity of a partial graph 1124A extracted from the trouble knowledge DB 1124 are integrated to create integrated graph data 2162.

Referring again to FIG. 2, in the graph integrating process 2160, the trouble knowledge DB 1124 illustrated in FIG. 1B is searched (2161), and a part including the components (“diesel mechanism” and “electric pump” in FIG. 4J) in the graph data 2154 subjected to the data matching is extracted. A component connected to the component (named entity) by the “part of edge” and the part of component connected to the component by “part of edge” are extracted as the partial graph 1124A. FIG. 4K illustrates an example of the partial graph 1124A extracted in the embodiment.

By integrating the graph data 2154 (FIG. 4J) subjected to the data matching and the partial graph 1124A (FIG. 4K) on the basis of “diesel mechanism” as their common element, the integrated graph data 2162 as illustrated in FIG. 4L is obtained.

(Step S2170): In a trouble knowledge DB updating process 2170, the graph data 2162 obtained by the graph integrating process and the trouble knowledge DB 1124 are collated. When there is a discrepancy, an update instruction is given to the trouble knowledge DB 1124. A query to update the trouble knowledge DB 1124 may be generated and executed.

For example, the part surrounded by a broken line 2162A in the graph data 2162 does not exist in the trouble knowledge DB 1124 in FIG. 1B. Consequently, by adding this part (2162A) to the trouble knowledge DB 1124 in FIG. 4J, an updated trouble knowledge DB 1124A illustrated in FIG. 4M (the part surrounded by the broken line is the updated part) is obtained.

By the processes of the steps, an updating process 2100 of the trouble knowledge DB 1124 is completed. In a trouble diagnosing process 2200, by the trouble diagnosing program 1121B, the cause of the trouble can be diagnosed by finding the occurrence place of the trouble, specifying the cause, and the like on the basis of the trouble information such as the trouble report and the trouble knowledge DB 1124.

Although the configuration of updating the trouble knowledge DB 1124 on the basis of the data matching process and the like has been described in the present embodiment, according to a state or the like of a plurality of times of the data matching process, a process of updating the HW knowledge DB 1122 such as changing of a term specified as a synonym (Synonym field) in the HW knowledge DB 1122 to a representative entity may be also performed. The configuration information of the hardware in the trouble knowledge DB 1124 may be updated by analyzing design-related information regarding a device and a system by a method similar to the above-described process in place of the trouble report.

As described above, according to the present embodiment, a database by which even a trouble report including fluctuations and the like in description and expressions for the same incident can be properly diagnosed can be configured.

### Second Embodiment

In the foregoing embodiment, a model which generates a text in response to an input directive is used as the language processing model. There may be, however, a case where execution is not always easy in an environment in which calculation resource is limited or an environment in which the data use range is limited.

In the present embodiment, an example of using an LLM of an encoder configuration capable of obtaining a high-degree vector representation (embedded expression) in response to an input text as a language processing model in which the process as the LLM is relatively light will be described.

Specifically, the language processing model in the present embodiment is a model which outputs a multidimensional numerical array in response to an input text. In a named entity extracting process, a word in a sentence is labeled on the basis of a numerical array output, and the result is output as a named entity list. In a relationship extracting process, a relationship list is output on the basis of a numerical array output and the named entity list. In a data matching process, a process of associating a named entity included in the named entity list with a term in the HW knowledge database by a similarity calculating process using a numerical array output is performed. In a graph integrating process, a process of associating the named entity included in the named entity list with the term in a trouble knowledge DB by the similarity calculating process using the numerical array output is performed.

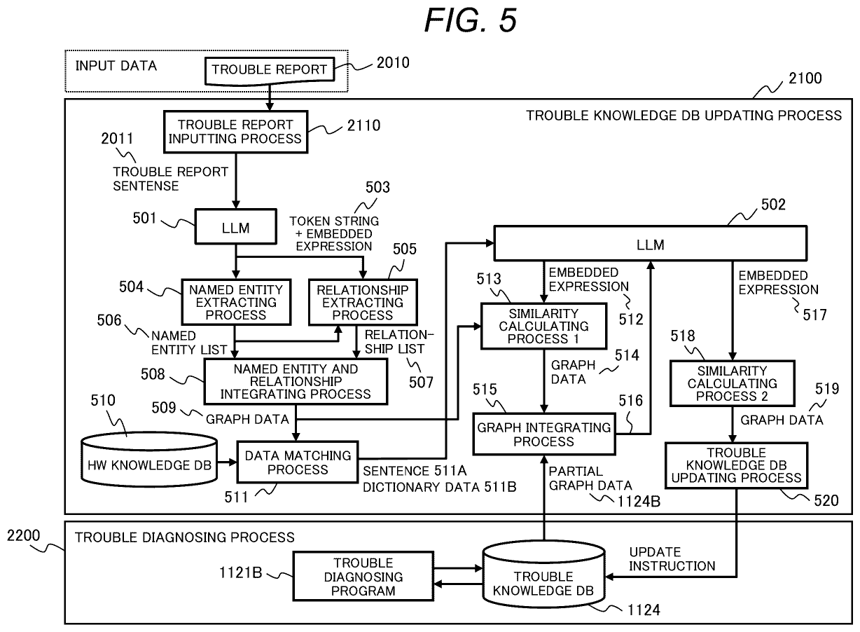

FIG. 5 is a diagram (corresponding to FIG. 2 in the first embodiment) for explaining the flow of a trouble document process in the present embodiment. The general configuration of the device and the basic process flow are similar to those in the first embodiment illustrated in FIGS. 1A and 3.

In FIG. 5, an LLM 501 and an LLM 502 are language processing models having the encoder configuration. Representative examples are the BERT (Bidirectional Encoder Representations from Transformers) and ROBERTa (Robustly optimized BERT approach). However, any language processing model outputting an embedded expression to a token may be used. The invention is not limited to a specific language processing model. It is assumed that each of the LLMs performs fine-tuning in accordance with a task. The LLM 501 performs fine-tuning for named entity extraction and relationship extraction, and the LLM 502 performs fine-tuning for a named entity ambiguity solving task.

Hereinafter, a process of updating the trouble knowledge DB 1124 in the present embodiment will be described with reference to FIG. 5.

In the LLM 501, a token string obtained by dividing the trouble report sentence 2011 similar to that illustrated in FIG. 4B into units called tokens on the basis of the result of the morphological analysis or the like and an embedded expression 503 as a numerical expression of each token via a neural network. For example, when “diesel engine made automatic stop due to breakage of cooling pump.” is given as the trouble report sentence 2011 to the LLM 501, [“diesel”, “engine”, “made”, “automatic”, “stop”, “due”, “to”, “breakage”, “of”, “cooling”, “pump”, “.”] is obtained as a token string, and [v1, v2, . . . , v12] (v denotes a plurality of floating-point values) are obtained as numerical expressions of the tokens.

The graph data and dictionary data in the LLM 501 is used at the time of calculating an input expression vector to a neutral network.

In a named entity extracting process 504, a named entity is extracted from a sentence by tagging the named entity token by token on the basis of the embedded expression and the token string as an output of the LLM 501. As a method of the tagging, an IOB (Inside-Outside-Beginning) notation or the like can be mentioned. For example, according to the IOB notation, the tokens [“cooling”, “pump”, “of”, “breakage”, “due”, “to”, “diesel”, “engine”, “made”, “automatic”, “stop”, “.”] are tagged by [B, I, O, B, O, O, B, I, O, B, I, O,O,O]. As a named entity list 506, [“cooling pump”, “breakage”, “diesel engine”, “automatic stop”] are extracted.

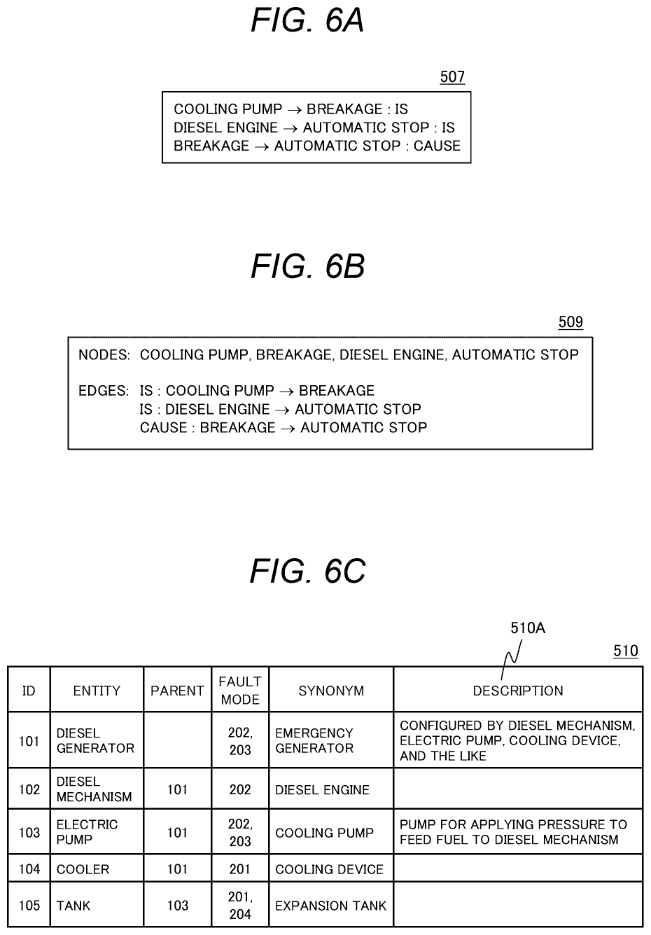

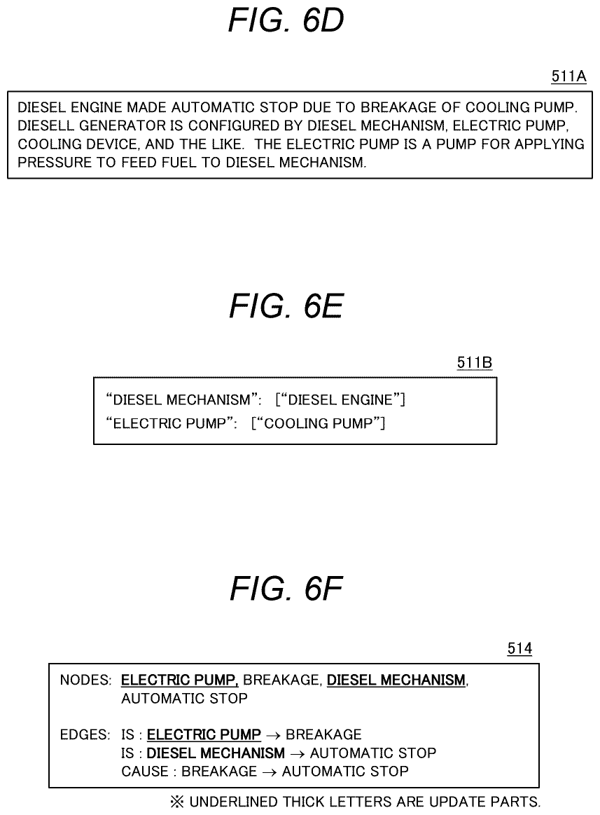

In a relationship extracting process 505, based on the embedded expression and the token string as an output of the LLM 501 and the above-described named entity list 506, the relationship among the named entities is labelled, the relationship is extracted, and a relationship list 507 as illustrated in FIG. 6A is output. It is similar to the relationship list 2132 (FIG. 4F) in the first embodiment.

A named entity and relationship integrating process 508 is similar to the named entity and relationship integrating process 2140 in the first embodiment. That is, graph data 509 as illustrated in FIG. 6B obtained by integrating the named entity list 506 and the relationship list 507 is output. It is similar to the graph data 2141 in FIG. 4G.

A data matching process 511 collates a named entity included in the graph data 509 output from the named entity and relationship integrating process 508 (the data in the named entity list 506 output from the named entity extracting process 504) and a term in a HW knowledge DB 510. The HW knowledge DB 510 of the present embodiment has, as illustrated in FIG. 6C, a use example and an explanatory sentence of a term in a “Description” column 510A in addition to the components of the HW knowledge DB 1122A (FIG. 1C) of the first embodiment.

As the result of collation, in the case where a named entity which is not included in “Entity” in the HW knowledge DB 510 exists, the information of a related term is obtained from the HW knowledge DB 510, and sentences 511A obtained by adding the explanation sentence of the term to the trouble report sentence are generated and output together with dictionary data 511B.

In the case of this example, the named entities “diesel engine” and “cooling pump” are not included in “Entity” in the HW knowledge DB 510. Consequently, explanation sentences (Description) of “ID=101: diesel generator” and “ID=103: electric pump” as terms related to the named entities are added to the trouble report sentence, thereby generating the sentences 511A as illustrated in FIG. 6D. The dictionary data 511B which is output at the same time is, for example, data of synonyms of the terms extracted from the HW knowledge DB 510 as illustrated in FIG. 6E.

In the LLM 502, the sentence 511A is converted to an embedded expression 512 by using the dictionary data 511B.

In a similarity calculating process 1 (513), the similarity among different named entities (“cooling pump”, “diesel engine”, “diesel generator”, “diesel mechanism”, and “cooling device”) output from the LLM 502 is calculated by a value from 0 to 1 on the basis of the embedded expression 512 output from the LLM 502, and graph data 514 (FIG. 6F) in which each term in the graph data 509 having high similarity to a term in the HW knowledge DB 510 (for example, the similarity is 0.98 or higher) is unified to the term is output (the content is equivalent to that of FIG. 4J). For calculation of the similarity, for example, a method using cosine similarity, a predictive value of a token tag using a softmax function, or the like may be used. Alternatively, another method may be used.

In a graph integrating process 515, the graph data 514 obtained by the similarity calculating process 1 (513) and the partial graph data 1124B of the trouble knowledge DB 1124 related to the graph data 514 is obtained. Both (516) of the data is converted to an embedded expression 517 in the LLM 502. In a similarity calculating process 2 (518), a corresponding relation among named entities in both of the data is collated. When the corresponding relation is obtained, the graph data 514 and the partial graph data 1124B is integrated to obtain integrated graph data 519 similar to that illustrated in FIG. 4L.

The other processes are similar to those in the first embodiment.

As described above, according to the present embodiment, by using an LLM having the encoder configuration obtaining a high-degree vector expression (embedded expression) in response to an input text as a language processing model in which the process is relatively light as the LLM, also in an environment in which the calculation resources are limited and an environment in which the data use range is limited, in a manner similar to the first embodiment, a database by which a trouble report including fluctuations in description and expression for the same incident can be properly diagnosed can be configured.

### Third Embodiment

In the present embodiment, a device of performing verification and feedback on results of the named entity and relationship extracting process and the data matching process in the first embodiment and re-executing the named entity extracting process (step S2120) and the relationship extracting process (step S2130) is added.

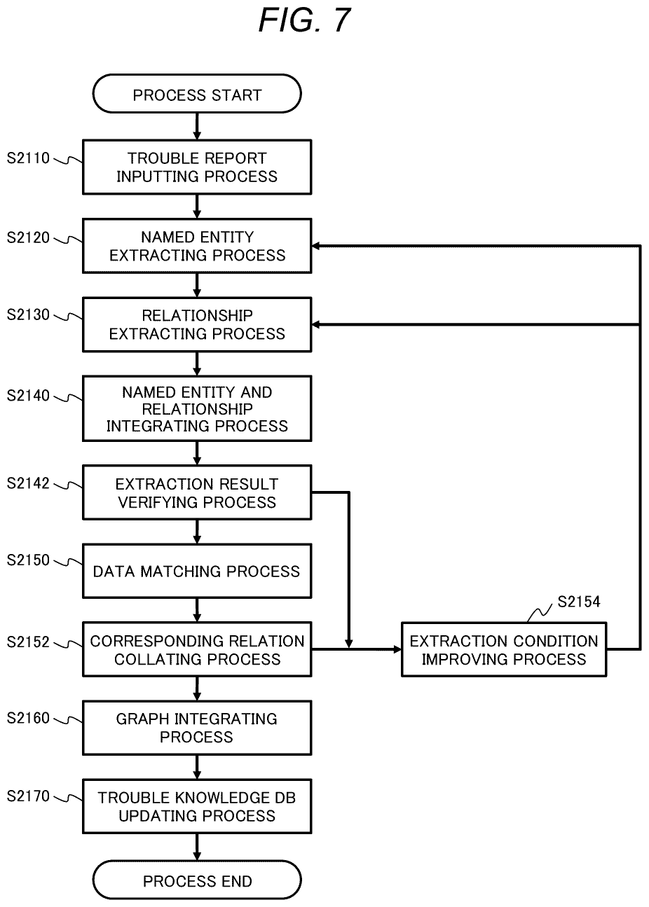

FIG. 7 illustrates a flowchart of the present embodiment. The same reference numerals are designated to the process steps which are the same as those in the first embodiment. An extraction result verifying process (step S2142) is a process of outputting an instruction to evaluate the graph data 2141 (FIG. 4G) as an output of the named entity and relationship integrating process (step S2140) and re-execute the named entity extracting process (step S2120) or the relationship extracting process (step S2130) in accordance with the evaluation result.

As the method of evaluating the graph data 2141, a combination of an evaluation by the morphological analysis of named entities for the case where a plurality of named entities are included in one extracted named entity, an evaluation paying attention to a graph structure such as acyclicity of the causal relation, an evaluation by determination of breach to a relationship classification rule based on classification of named entities, and the like is assumed, and a method which is proper according to a target product is applied.

For example, in the case where a plurality of named entities are included, when a sentence is recognized as named entities like “breakage of electric pump”, the sentence has to be further disassembled to “electric pump” and “breakage” by the morphological analysis. As a concrete example of the evaluation paying attention to the graph structure, in the case where a bidirectional cause edge exists between “breakage” and “automatic stop”, it has to be corrected to a unilateral cause edge. Further, as a concrete example of the evaluation based on classification of named entities, in the case where the cause edge exists between “electric pump” and “diesel engine”, the cause edge has to be eliminated.

The corresponding relation collating process (step S2152) is a process of outputting an instruction to evaluate a gap or the like in the causal relation on the basis of the term in the HW knowledge DB 1122 associated with the graph data 2154 (FIG. 4J) obtained as a result of the data matching process (step S2150), and re-execute the named entity extraction or relationship extraction in accordance with the result.

For example, as an example of a gap in the causal relation, when the cause is connected from “blocking” of the tank to “continuous operation failure” of the diesel generator in the trouble knowledge DB 1124 illustrated in FIG. 1B, “water amount shortage”, “overheat”, or the like between them has to be filled in.

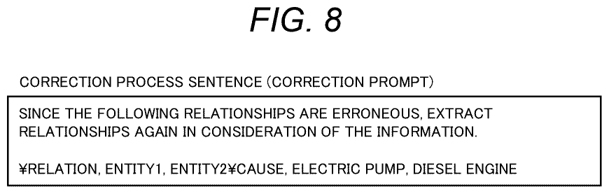

The extraction condition improving process (step S2154) is a process of generating a correction prompt on the basis of an instruction obtained by the above-described extraction result verifying process (step S2142) or the corresponding relation collating process (step S2152) and giving it to the named entity extracting process (step S2120) or the relationship extracting process (step S2130). FIG. 8 illustrates an example of a correction prompt.

The other process steps are the same as those in the first embodiment.

As described above, according to the present embodiment, verification and feedback are performed on the results of the named entity and relationship extracting process and the data matching process, and the process is re-executed. Consequently, the precision of the processes can be improved.

### Reference Signs List

1000: trouble document processing device
1100: processor system
1110: processor unit
1120: memory resource unit
1121: program unit
1121A: updating process program
1121B: trouble diagnosis process program unit
1122: hardware (HW) knowledge DB unit
1123: language processing model
1124: trouble knowledge DB unit
1125: trouble report storing unit
1130: network interface unit
1140: user interface unit
1200: input/output device
1300: network

What is claimed is:

1. A trouble document processing device of extracting a cause of a trouble from a trouble report describing a trouble of a product and creating a trouble knowledge database, comprising:
a trouble knowledge database storing information related to the trouble;
a hardware knowledge database storing a name of a part in a product, a synonym of the name, and design information;
an input/output unit inputting and outputting information; and
a processor unit performing a predetermined computing process,
wherein the processor unit performs
a named entity extracting process of extracting a term related to a component in a target product and a trouble of the component from a trouble report sentence based on the trouble report;
a relationship extracting process of extracting a relationship between named entities from the trouble report sentence;
a named entity and relationship integrating process of generating first graph data from a result of the named entity extracting process and a result of the relationship extracting process;
a data matching process of obtaining second graph data derived by collating a named entity in the first graph data with the hardware knowledge database and correcting a synonymous element;
a graph integrating process of generating third graph data by connecting the second graph data and the named entity in the trouble knowledge database; and
a trouble knowledge database updating process of collating the third graph data and the trouble knowledge database and updating the trouble knowledge database.

2. The trouble document processing device according to claim 1, wherein
the processor unit executes the named entity extracting process, the relationship extracting process, and the data matching process by using a predetermined language processing model.

3. The trouble document processing device according to claim 1, wherein
the hardware knowledge database
has a term of a component in a device, an inclusion relation, a failure mode, and synonym information and
updates information on the basis of a result of the data matching process.

4. The trouble document processing device according to claim 1, wherein
the components of the hardware knowledge database are stored in the trouble knowledge database, and
the processor unit performs the data matching process by using the trouble knowledge database.

5. The trouble document processing device according to claim 1, wherein
the trouble knowledge database is a knowledge graph expressing a phenomenon and an occurrence place related to a trouble, and a relationship such as a causal relation.

6. The trouble document processing device according to claim 5, wherein
the trouble knowledge database is a Bayesian network in which the causal relation includes probability information.

7. The trouble document processing device according to claim 1, wherein
the hardware configuration information of the trouble knowledge database is analyzed by the same flow from a design related text, and the trouble knowledge database is updated.

8. The trouble document processing device according to claim 2, wherein
the language processing model is a model of outputting an answer sentence in response to an input directive, and
the directive has
a sentence instructing a procedure of the named entity extracting process,
a sentence instructing a procedure of the relationship extracting process, and
a sentence instructing a procedure of the data matching process.

9. The trouble document processing device according to claim 2, wherein
the language processing model is a model of outputting a multidimensional numerical array in response to an input text,
a word in a sentence is labelled on the basis of a numerical array output and the result is output as a named entity list in the named entity extracting process,
a relationship list is output on the basis of the numerical array output and the named entity list in the relationship extracting process,
a process of associating a named entity included in the named entity list with a term in the hardware knowledge database is performed by a similarity calculating process using the numerical array output in the data matching process, and
a process of associating a named entity included in the named entity list with a term in the trouble knowledge database by a similarity calculating process using a numerical array output in the graph integrating process.

10. The trouble document processing device according to claim 1, wherein
the processor unit performs
an extraction result verifying process of generating an instruction to evaluate a result of the named entity and relationship integrating process and re-execute the named entity extracting process or the relationship extracting process in accordance with the evaluation result,
a corresponding relation collating process of generating an instruction to evaluate a result of the data matching process and re-execute the named entity extracting process or the relationship extracting process in accordance with the evaluation result, and
an extraction condition improving process of generating a prompt to correct the content of the named entity extracting process or the relationship extracting process on the basis of the instructions generated in the extraction result verifying process and the corresponding relation collating process.

11. A trouble document processing method of extracting a cause of a trouble from a trouble report describing a trouble of a product and creating a trouble knowledge database, comprising:
a named entity extracting process of extracting terms related to a component in a target product and a trouble of the component from a trouble report sentence based on the trouble report;
a relationship extracting process of extracting a relationship between named entities from the trouble report sentence;
a named entity and relationship integrating process of generating first graph data from a result of the named entity extracting process and a result of the relationship extracting process;
a data matching process of obtaining second graph data derived by collating a named entity in the first graph data with the first database storing the name of a part in a product, its synonym, and design information, and correcting a synonymous element;
a graph integrating process of generating third graph data by connecting the second graph data and the named entity in the second database storing information related to a trouble of a product; and
a database updating process of collating the third graph data and the second database and updating the second database.
